(19) United States
(12) Patent Application Publication
(10) Pub. No.: US 2011/0039098 A1
(43) Pub. Date: Feb. 17, 2011

(54) GAS-BARRIER FILMS AND SHEETS

(76) Inventors: Roberto Forloni, Milan (IT); Eugenio Sergio Longo, Milan (IT); Paolo Ciocca, Novara (IT)

Correspondence Address: LAW DEPARTMENT;SEALED AIR CORPORATION, P.O. BOX 464, DUNCAN, SC, 29334, US

(21) Appl. No.: 12/865,008

(22) PCT Filed: Jan. 29, 2009
(86) PCT No.: PCT/EP09/00560

§ 371 Date: Oct. 29, 2010

(30) Foreign Application Priority Data
Jan. 31, 2008 (EP) 08001799.9

(51) Int. Cl. B32B 27/08

(52) U.S. Cl. 428/339

(57) ABSTRACT

Multi-layer, gas-barrier, either cast or solid-state oriented, heat-shrinkable, annealed or heat-set, films and sheets suitable for packaging applications which comprise a microlayer sequence (a) comprising a number n of identical repeating units (a′), each comprising the sequence A/B/C, wherein A is a layer comprising a major proportion of one or more thermoplastic (co)polyamides, B is either a layer comprising a major proportion of one or more ethylene-vinyl alcohol copolymers or a layer comprising a major proportion of a (co)polyamide characterized by an OTR of less than 100 cm³.25 μm/m².day.bar at 23° C. and 0% of RH, C is either nil or a layer comprising a major proportion of one or more thermoplastic (co)polyamides, and n stands for an integer of 3 or more, an outer layer (b) comprising one or more polymers selected from polyolefins, modified polyolefins, and thermoplastic (co)polyesters, and a tie layer between the outer layer (b) and the microlayer sequence (a).

The present invention relates to gas-barrier films and sheets comprising an alternating sequence of polyamide or of ethylene-vinyl alcohol copolymer (EVOH) and polyamide microlayers.

More particularly the invention refers to either cast or oriented, heat-shrinkable, annealed or heat-set, gas-barrier films and sheets suitable for packaging applications which comprise an alternating sequence of polyamide or of ethylene-vinyl alcohol copolymer (EVOH) and polyamide microlayers.

### BACKGROUND OF THE INVENTION

Gas-barrier structures comprising polyamide and optionally EVOH layers are widely known in the literature and used commercially. Cast, fairly thick, structures are typically used for thermoforming applications, cast thinner structures are generally used and described for the manufacture of pouches, while oriented, either heat-shrinkable, annealed or heat-set, thinner films are generally used for (shrink) wrapping or (shrink) lidding applications. Examples of such structures are those comprising a polyamide layer where the polyamide is endowed with particularly high gas-barrier properties, such as polyamide nanocomposites, certain partially aromatic copolyamides, or certain amorphous polyamides, or, for higher gas-barrier properties, those comprising an EVOH layer and a polyamide layer directly adhering to one of the EVOH surfaces or two polyamide layers sandwiching the EVOH one.

WO 00/76765, which is directed to barrier materials made of extruded microlayers, describes i.a. flexible films or tapes constructed of extruded microlayers, wherein polyamides and EVOH polymers are among the various materials indicated for use in the microlayers. The properties of stacks of microlayers of PA6, EVOH and repeating units PA6/EVOH/PA6 are discussed in the text of WO 00/76765 in comparison with those of similar structures with single polymer layers of a thickness equivalent to the sum of the thickness of the same polymer microlayers. Said properties are improved mechanical properties (such as improved puncture resistance and improved resistance to flex cracking) that according to WO 00/76765—in case of films comprising both EVOH and polyamide microlayers—are however obtained together with an impairment of the gas-barrier properties.

It has now been found that when in the structures that comprise a stack of polyamide and EVOH microlayers said microlayer stack amounts to less than 50% of the total thickness, improved gas-barrier properties, particularly in humid conditions, are obtained. It has also been found that in these cast structures the mechanical as well the thermoforming properties are either improved or at least maintained with respect to the corresponding structures where the stack of microlayers is replaced by single thicker layers and finally that these structures can be cold oriented much more easily, using conventional stretching apparatus and conditions, such as a sequential tenter frame stretching process, giving mono- or preferably bi-axially oriented films where the gas-barrier as well as the mechanical properties are further improved.

### SUMMARY OF THE INVENTION

A first object of the present invention is therefore a multi-layer, gas-barrier, thermoplastic film or sheet comprising
a microlayer sequence (a) comprising a number n of identical repeating units (a′), each comprising the microlayer sequence A/B/C, wherein A is a microlayer comprising a major proportion of one or more thermoplastic (co)polyamides, B is either a microlayer comprising a major proportion of one or more ethylene-vinyl alcohol copolymers or a microlayer comprising a major proportion of a (co)polyamide characterized by an OTR of less than 100 cm³.25 μm/m².day.bar at 23° C. and 0% of RH, and C is either nil or a microlayer comprising a major proportion of one or more thermoplastic (co)polyamides, and n is an integer of 3 or more, said microlayer sequence (a) having a thickness of less than 50% of the total thickness of the film or sheet,
an outer layer (b) comprising one or more polymers selected from polyolefins, modified polyolefins, and thermoplastic (co)polyesters, and
a tie layer positioned between the outer layer (b) and the microlayer sequence (a).

The films and sheets according to the present invention show improved gas-barrier properties, particularly in humid conditions. Said improved gas-barrier properties are often coupled with improved mechanical properties and/or improved thermoformability and cold stretchability properties with respect to the corresponding films and sheets containing single layers of the same resins of a thickness corresponding to the sum of the thicknesses of the n layers in the alternating sequence (a). The improvement in stretchability and thermoformability is particularly remarkable for the structures containing EVOH as these structures can be solid-state oriented easily and with high stretching ratios under conditions (e.g., sequential stretching) that would be problematic for the corresponding structures with thicker single layers.

In a preferred embodiment of the present invention the multi-layer, gas-barrier, thermoplastic film or sheet will comprise
a microlayer sequence (a) comprising a number n of identical repeating units (a′), each comprising the microlayer sequence A/B/C, wherein A is a microlayer comprising a major proportion of one or more thermoplastic (co)polyamides, B is either a microlayer comprising a major proportion of one or more ethylene-vinyl alcohol copolymers or a microlayer comprising a major proportion of a (co)polyamide characterized by an OTR of less than 100 cm³.25 μm/m².day.bar at 23° C. and 0% of RH, and C is either nil or a microlayer comprising a major proportion of one or more thermoplastic (co)polyamides, and n is an integer of 3 or more, said microlayer sequence (a) having a thickness of less than 50% of the total thickness of the film,
an outer layer (b) comprising one or more polymers selected from polyolefins, modified polyolefins, and thermoplastic (co)polyesters,
a tie layer between the outer layer (b) and the microlayer sequence (a), and
a second outer layer (c).

In a more preferred embodiment of the present invention the multi-layer, gas-barrier, thermoplastic film or sheet will comprise
a microlayer sequence (a) comprising a number n of identical repeating units (a′), each comprising the microlayer sequence A/B/C, wherein A is a microlayer comprising a major proportion of one or more thermoplastic (co)polyamides, B is either a microlayer comprising a major proportion of one or more ethylene-vinyl alcohol copolymers or a microlayer comprising a major proportion of a (co)polyamide characterized by an OTR of less than 100 cm³.25 μm/m².day.bar at 23° C. and 0% of RH, and C is either nil or a microlayer comprising a major proportion of one or more thermoplastic (co)polyamides, and n is an integer of 3 or more, said microlayer sequence (a) having a thickness of less than 50% of the total thickness of the film,
an outer layer (b) comprising one or more polymers selected from polyolefins, modified polyolefins, and thermoplastic (co)polyesters,
a tie layer between the outer layer (b) and the microlayer sequence (a),
a second outer layer (c), and
a tie layer positioned between the second outer layer (c) and the microlayer sequence (a).

The objects, advantages, and features of the present invention will be more readily understood and appreciated by reference to the detailed description of the invention.

### DEFINITIONS

While the term “film” generally refers to plastic web materials having a thickness of 250 μm or less, and the term “sheet” to those with a thickness of more than 250 μm, for the sake of simplicity in the present description the term “film” is used in a generic sense to include any flexible plastic web, regardless of whether it is film or sheet.

As used herein the phrases “inner layer” and “internal layer” refer to any film layer having both of its principal surfaces directly adhered to another layer of the film.

As used herein, the phrase “outer layer” refers to any film layer having only one of its principal surfaces directly adhered to another layer of the film

As used herein, the phrases “seal layer”, “sealing layer”, “heat seal layer”, and “sealant layer”, refer to the film outer layer which will be involved in the sealing of the film to close the package and that will thus be in contact with, or closer to, the packaged product.

As used herein, the phrase “tie layer” refers to any inner film layer having the primary purpose of adhering two layers to one another.

As used herein, the phrases “longitudinal direction” and “machine direction”, herein abbreviated “MD”, refer to a direction “along the length” of the film, i.e., in the direction of the film as the film is formed during extrusion and/or coating.

As used herein, the phrase “transverse direction”, herein abbreviated “TD”, refers to a direction across the film, perpendicular to the machine or longitudinal direction.

As used herein, the term “orientation” refers to the process of solid-state orientation, i.e., the orientation process carried out at a temperature higher than the highest Tg (glass transition temperature) of the resins making up the majority of the structure and lower than the highest melting point of at least some of the film resins, i.e. at a temperature at which at least some of the resins making up the structure are not in the molten state. The orientation may be mono-axial, either longitudinal or transversal, or bi-axial.

As used herein the phrases “heat-shrinkable,” “heat-shrink,” and the like, refer to the tendency of the film to shrink upon the application of heat, i.e., to contract upon being heated, such that the size of the film decreases while the film is in an unrestrained state. As used herein said term refer to oriented films with a free shrink in at least one of the machine and the transverse directions, as measured by ASTM D 2732, of at least 5% at 95° C.

As used herein, the term “homo-polymer” is used with reference to a polymer resulting from the polymerization of a single monomer, i.e., a polymer consisting essentially of a single type of mer, i.e., repeating unit.

As used herein, the term “co-polymer” refers to polymers formed by the polymerization reaction of at least two different monomers. When used in generic terms the term “co-polymer” is also inclusive of, for example, ter-polymers. The term “co-polymer” is also inclusive of random co-polymers, block co-polymers, and graft co-polymers.

As used herein, the terms “(co)polymer” and “polymer” are inclusive of homo-polymers and co-polymers.

As used herein, the phrase “heterogeneous polymer” refers to polymerization reaction products of relatively wide variation in molecular weight and relatively wide variation in composition distribution, i.e., typical polymers prepared, for example, using conventional Ziegler-Natta catalysts.

As used herein, the phrase “homogeneous polymer” refers to polymerization reaction products of relatively narrow molecular weight distribution and relatively narrow composition distribution. This term includes those homogeneous polymers prepared using metallocene, or other single-site type catalysts.

As used herein, the term “polyolefin” refers to any polymerized olefin, which can be linear, branched, cyclic, aliphatic, aromatic, substituted, or unsubstituted. More specifically, included in the term polyolefin are homo-polymers of olefin, co-polymers of olefin, co-polymers of an olefin and an non-olefinic co-monomer co-polymerizable with the olefin, such as vinyl monomers, modified polymers thereof, and the like.

As used herein the term “modified polyolefin” is inclusive of modified polymer prepared by co-polymerizing the homo-polymer of the olefin or co-polymer thereof with an unsaturated carboxylic acid, e.g., maleic acid, fumaric acid or the like, or a derivative thereof such as the anhydride, ester or metal salt or the like. It is also inclusive of modified polymers obtained by incorporating into the olefin homo-polymer or co-polymer, by blending or preferably by grafting, an unsaturated carboxylic acid, e.g., maleic acid, fumaric acid or the like, or a derivative thereof such as the anhydride, ester or metal salt or the like.

As used herein, the term “adhered”, as applied to film layers, broadly refers to the adhesion of a first layer to a second layer either with or without an adhesive, a tie layer or any other layer therebetween, and the word “between”, as applied to a layer expressed as being between two other specified layers, includes both direct adherence of the subject layer to the two other layers it is between, as well as a lack of direct adherence to either or both of the two other layers the subject layer is between, i.e., one or more additional layers can be imposed between the subject layer and one or more of the layers the subject layer is between.

In contrast, as used herein, the phrase “directly adhered” is defined as adhesion of the subject layer to the object layer, without a tie layer, adhesive, or other layer therebetween.

When referred to an overall structure, the term “gas-barrier” is used herein to identify structures characterized by an Oxygen Transmission Rate (evaluated at 23° C. and 0% R.H. according to ASTM D-3985) of less than 300 cm³/m².day.bar.

As used herein the terms “polyamide layer” or “ethylene-vinyl alcohol layer” (or “EVOH layer”) refer to layers comprising a major proportion, i.e., >50 wt. %, such as >60 wt. %, >70 wt. %, >80 wt. %, >90 wt. %, >95 wt. %, up to about 100 wt. %, of one or more (co)polyamides or ethylene-vinyl alcohol copolymers (or “EVOH”) respectively, said amount being calculated on the overall weight of the layer considered.

### DETAILED DESCRIPTION OF THE INVENTION

A first object of the present invention is a multi-layer, gas-barrier, thermoplastic film or sheet comprising
a microlayer sequence (a) comprising a number n of identical repeating units (a′), each comprising the microlayer sequence A/B/C, wherein A is a microlayer comprising a major proportion of one or more thermoplastic (co)polyamides, B is either a microlayer comprising a major proportion of one or more ethylene-vinyl alcohol copolymers or a microlayer comprising a major proportion of a (co)polyamide characterized by an OTR of less than 100 cm³.25 μm/m².day.bar at 23° C. and 0% of RH, and C is either nil or a microlayer comprising a major proportion of one or more thermoplastic (co)polyamides, and n is an integer of 3 or more, said microlayer sequence (a) having a thickness of less than 50% of the total thickness of the film or sheet,
an outer layer (b) comprising one or more polymers selected from polyolefins, modified polyolefins, and thermoplastic (co)polyesters, and
a tie layer between the outer layer (b) and the microlayer sequence (a).

While in its most basic structure, that represents a preferred embodiment of the present invention, each repeating unit (a′) of the microlayer sequence (a) comprises only layers A, B, and C, one directly adhered to the other in the order indicated in the sequence A/B/C, it will be appreciated that said repeating unit may also contain one or more additional microlayers. Said additional microlayers can be interposed between the A and B and/or the B and C layers, particularly when B is an EVOH layer, and/or they may be positioned on one or both sides of the indicated sequence, i.e., on the outer surfaces of A and/or C layers. In another preferred embodiment however in each repeating unit (a′) the A/B/C layers are directly adhered one to the other in the order indicated in the sequence and additional microlayers are positioned on one or both sides of said sequence. The maximum number of microlayers that will compose each identical repeating unit (a′) will depend essentially on the extrusion equipment employed and repeating units composed of up to 9 or 10 microlayers may be easily foreseen. Non limitative examples are for instance repeating units (a′) composed of 5-layers with the following sequences D/A/B/C/E or F/D/A/B/C, repeating units (a′) composed of 6-layers with the following sequence F/D/A/B/C/E or repeating units (a′) composed of 7-layers with the following sequence F/D/A/B/C/E/G, wherein the polymers or polymer blends used for those layers indicated with D, E, F, and G will be suitably selected to further improve the properties of the end structure or to reduce its cost and provide for a sufficiently cohesive structure. For the sake of simplicity in the following description and claims the microlayer sequence (a) will be indicated as (A/B/C)ₙ, wherein (A/B/C) indicates a repeating unit (a′) that comprises layers A, B, and possibly C in the order indicated but may comprise also other microlayers as summarized above, and n is the number of repeating units (a′) in the microlayer sequence (a). The one or more additional microlayers that might possibly be present in the repeating unit (a′) typically will comprise polyolefins, modified polyolefins, (co)polyamides, and/or (co)polyesters.

Layer A, as well as layer C, when said latter layer is present, are microlayers comprising a major proportion of one or more thermoplastic polyamides and/or co-polyamides. When C is present, its composition may be the same as that of layer A or it may be different. Suitable thermoplastic homo-polyamides that can be used for layer A as well as for layer C, if present, are those obtained starting from the corresponding lactams by hydrolytic polymerization, such as polyamide 6 and polyamide 12, or those obtained by polycondensation from the corresponding amino acid, such as polyamide 11, or those obtained by the polycondensation of a diamine and a dicarboxylic acid. Suitable diamines, as well as suitable dicarboxylic acids can be aliphatic, cycloaliphatic, or aromatic. Representative examples of diamines include aliphatic linear and branched diamines such as trimethylenediamine, tetramethylenediamine, pentamethylenediamine, hexamethylenediamine, octamethylenediamine, decamethylenediamine, dodeca-methylenediamine, hexadecamethylenediamine, 2,2-dimethylpentamethylenediamine, 2,2,4-trimethylhexamethylenediamine, and 2,4,4 trimethylpentamethylenediamine, cycloaliphatic diamines such as 4,4-diaminocyclohexylmethane and 3,3-dimethyl-4,4-diaminocyclohexylmethane, and aromatic diamines such as p-phenylenediamine, and m-xylylendiamine. Representative examples of diacids include aliphatic dicarboxylic acids, such as adipic acid, sebacic acid, octadecanedioic acid, pimelic acid, suberic acid, azelaic acid, dodecanedioic acid, and glutaric acid, and aromatic dicarboxylic acids, such as such as isophthalic acid and terephthalic acid.

Suitable co-polyamides for layer A as well as for layer C, if present, are obtained by polymerisation carried out with several starting monomers, e.g., one or more lactams or aminoacids and/or one or more diamines and one or more diacids, where representative examples of suitable lactams, diamines, and diacids are those indicated above.

Representative examples of homo-polyamides that can suitably be employed in layers A and C of the microlayer sequence are polyamide 6 (poly-ε-caprolactam), polyamide 12 (poly-ω-laurolactam), polyamide 11 (poly-aminoundecanoic acid), polyamide 66 (poly(hexamethylene adipamide)), polyamide 69 (poly(hexamethylene azelamide)), polyamide 610 (poly(hexamethylene sebacamide)), polyamide 612 (poly(hexamethylene dodecanediamide), polyamide 88 (poly(octamethylene suberamide)), etc. Representative examples of suitable co-polyamides include polyamide 6/12 (caprolactam/laurolactam copolymer), polyamide 6/66 (caprolactam/hexamethylene adipamide copolymer), polyamide 6/69 (caprolactam/hexamethylene azelamide), polyamide 66/610 (hexamethylene adipamide/hexamethylene sebacamide), polyamide 6/6I (caprolactam/hexamethylene isophthalamide copolymer), 6/6T (caprolactam/terephthalamide copolymer), 6I/6T (hexamethylene isophthalamide/hexamethylene terephthalamide copolymer), polyamide 66/6T (hexamethylene-adipamide/hexamethylene terephthalamide copolymer), polyamide MXDI/MXD6 (m-xylylene isophthalamide/m-xylylene adipamide copolymer), polyamide Dec. 6, 1966 (laurolactam/caprolactam/hexamethylene adipamide terpolymer), polyamide Jun. 66, 1969 (caprolactam/hexamethylene adipamide/hexamethylene-azelamide terpolymer), polyamide 6/MXDT/MXDI (caprolactam/m-xylylene terephthalamide/m-xylylene isophthalamide terpolymer), etc. Conventional nomenclature typically lists the major constituent of a copolymer before the slash (“/”) in the name of a copolymer; however, in this application the constituent listed before the slash is not necessarily the major constituent unless specifically identified as such. For example, unless the application specifically notes to the contrary, “polyamide 6/66” and “polyamide 66/6” may be considered as referring to the same type of copolyamide. Polyamide copolymers may include the most prevalent polymer unit in the copolymer (e.g., hexamethylene adipamide as a polymer unit in the copolymer nylon-66/6) in mole percentages ranging from any of the following: at least about 50%, at least about 60%, at least about 70%, at least about 80%, and at least about 90%, and may include the second most prevalent polymer unit in the copolymer (e.g., caprolactam as a polymer unit in the copolymer nylon-66/6) in mole percentages ranging from any of the following: less than about 50%, less than about 40%, less than about 30%, less than about 20%, less than about 10%.

In the A layer, as well as in layer C, if present, a single (co)polyamide or a blend of (co)polyamides can be used as the resin making up the major proportion of the layers.

In one preferred embodiment the polyamide(s) and/or co-polyamide(s) for use in layers A and C (if present) of the repeating unit of the microlayer sequence (a) are crystalline or semi-crystalline homo- or co-polyamides. Particularly preferred in said embodiment are the crystalline or semi-crystalline (co)polyamides with a melting point of at least 200° C. Mostly preferred in particular are polyamide 6 and those (co)polyamides of polyamide 6 with a very small amount of 6I or 6T. In said preferred embodiment the (co)polyamide 6 can be employed alone or blended with an aliphatic co-polyamide such as polyamide 6/12, polyamide 6/66 and polyamide 6/69.

In another embodiment, preferred (co)polyamides for use in the A and C layers of the repeating unit of the microlayer sequence (a) are aliphatic (co)polyamides, such as polyamide 612, polyamide 6/12, polyamide 6/66 and polyamide 6/69, optionally blended with amorphous (co)polyamides.

In a preferred embodiment, in case layer C is present in the repeating unit (a′) of the microlayer sequence (a), the composition of said layer C corresponds to that of layer A.

Layer B in the repeating units of the microlayer sequence (a) is either a layer comprising a major proportion of one or more ethylene-vinyl alcohol copolymers or a layer comprising a major proportion of a (co)polyamide characterized by an OTR of less than 100 cm³.25 μm/m².day.bar at 23° C. and 0% of RH. In a preferred embodiment said layer B is an EVOH layer. When B is an EVOH layer, said layer may comprise one or more than one ethylene-vinyl alcohol copolymers. Said ethylene-vinyl alcohol copolymer or each of them in case of a blend of more than one ethylene-vinyl alcohol copolymers, may have an ethylene content of from about 25% to about 50%, such as for instance any of the following values: 25%, 30%, 33%, 35%, 38%, 40%, 44%, 48%, and 50%, by weight. Ethylene-vinyl alcohol copolymers may include saponified or hydrolyzed ethylene/vinyl acetate copolymers having a degree of hydrolysis of at least about any of the following values: 80%, 85%, 90% and 95%. Exemplary EVOH are commercially available from Nippon Goshei or Evalca Corporation having ethylene contents of 29, 32, 35, 38, 44, and 48 mole percent. Preferred ethylene-vinyl alcohol copolymers have ethylene content comprised between 29 and 48% by mole. Most preferred are copolymers with an ethylene content comprised between 32 and 44% by mole. Said EVOH copolymer may also be of a retortable grade, i.e., it may be recommended for the manufacture of structures suitable for retort packaging process, a process where the package is conditioned with steam at 121° C. for 30 minutes in order to sterilize its contents. In such a case preferred EVOH polymers will have an ethylene content in the lower part of the above range, typically from 29 to 38% by mole.

When B is a layer comprising a major proportion of a (co)polyamide characterized by an OTR of less than 100 cm³.25 μm/m².day.bar at 23° C. and 0% of RH, said (co)polyamide is typically chosen among certain partially aromatic polyamides, such as MXD6, certain partially aromatic co-polyamides, such as those formed from units derived from meta-xylylenediamine, adipic acid, and isophtahlic acid (MXD6/MXDI), certain amorphous (co)polyamides, such as 6I/6T, and nanopolyamides, e.g. nanopolyamide 6, nanopolyamide MXD6, nanopolyamide 6I/6T, etc. Nanopolyamides are polyamide compositions comprising a nanometer scale finely dispersed clay, such as, natural or synthetic phyllosilicates, preferably of the smectite group. Typically, but not exclusively, montmorillonite clay is employed. The nanoclay platelets used in the nanopolyamide composites have generally an average thickness comprised between about 1 nm and about 100 nm and an average length and average width comprised between about 50 and about 700 nm. The nanoclay platelets are present in the polyamide composition in an amount up to about 8% by weight, generally comprised between about 0.5 and about 5% by weight.

In a preferred embodiment when the B layer comprises a major proportion of a (co)polyamide characterized by an OTR of less than 100 cm³.25 μm/m².day.bar at 23° C. and 0% of RH, the composition of layer A and of layer C, if present, will be different from the composition of said layer B.

n, i.e., the number of repeating units (a′) in the microlayer sequence (a), is at least 3, and preferably at least 4. The number of repeating units can however be much higher than 3 or 4 or 5 or 6 and preferably it is a multiple of 3 or 4 or 5 or 6, typically dictated by the particular technology used for the manufacture of these structures. As it will be described in more details later on, these structures are in fact generally obtained using the multiplier technology, where the multi-layer melt flow corresponding to the first unit which is coextruded, i.e., (A/B/C), is splitted, longitudinally, into a number of packets, for example three or four, each having the same number and sequence of layers corresponding to that of the first unit; said packets are then recombined, stacked one on top of the other, to provide for an alternating sequence with three or four repeating units. Said combined melt flow, of a microlayer sequence (A/B/C)_{3 or 4} can then be splitted once more for example into three or four packets that are then re-combined and stacked one on top of the other, thus giving, in this specific example, structures with 9, or 12, or 16 repeating units. In their turn these can still be splitted and recombined one or more times. The number of packets in which each melt flow can be splitted is not limited to three or four, values that are given above only by way of example, but it can easily be higher. In particular the multiplier technology already available allows splitting a melt flow also in five or six packets that are then stacked, one on top of the other, and processed as described above where each further splitting step can foresee an equal or a different number of packets. In line of principle the number of multiplying steps can be as high as the equipment may allow and the resins may withstand. Typically said number is maintained between 1 and 6, preferably between 1 and 5, more preferably between 2 and 4 and the number of layers in the microlayer sequence can be as high as 300 or 400 or even more.

As in any coextrusion process, the polyamide(s) and/or co-polyamide(s), the ethylene-vinyl alcohol polymer(s), and any other possible resin for use in the microlayer sequence (a) will be selected and combined in the respective layers in such a way to give rheologically similar polymer streams in the co-extrusion process, i.e., polymer streams being sufficiently similar in viscosity at the temperatures chosen for the co-extrusion process to avoid significant interfacial instability.

The thickness of the microlayers in the repeating units (a′) of the alternating sequence (a) may vary, depending on e.g. the total thickness desired for the overall structure, the number n of repeating units in the sequence, the number of microlayers in each repeating unit, and whether the end structure is oriented or not, from about 0.01 μm up to about 5 μm, preferably from about 0.03 to about 4.5 μm, more preferably from about 0.05 to about 4.0 μm, even more preferably from about 0.07 to about 3.5 μm, yet more preferably from about 0.09 to about 3.0 μm, and most preferably from about 0.1 to about 2.0 μm.

The relative volume between layer B and the polyamide layer(s) A and possibly C in each repeating unit is preferably comprised between 1:20 and 5:1, more preferably between 1:15 and 4:1, even more preferably between 1:10 and 3:1 and yet even more preferably between 1:8 and 2:1.

In multi-layer, gas-barrier, thermoplastic film of the present invention also comprises an outer layer (b). Said outer layer (b) will comprise one or more polymers selected from the group consisting of polyolefins, modified polyolefins, polyesters and copolyesters.

Specific examples of suitable polyolefins include polyethylene homo-polymer, polypropylene homo-polymer, polybutene homo-polymer, ethylene-α-olefin co-polymer, propylene-α-olefin co-polymer, butene-α-olefin co-polymer, ethylene-unsaturated ester co-polymer, ethylene-unsaturated acid co-polymer, (e.g. ethylene-ethyl acrylate co-polymer, ethylene-butyl acrylate co-polymer, ethylene-methyl acrylate co-polymer, ethylene-acrylic acid co-polymer, and ethylene-methacrylic acid co-polymer), ethylene-vinyl acetate copolymer, ionomer resins, polymethylpentene, etc.

Preferred polyolefins for said layer (b) will be selected from the group of ethylene homopolymers, ethylene co-polymers, propylene homopolymers, propylene co-polymers and blends thereof.

Ethylene homo- and co-polymers particularly suitable for said outer layer (b) are selected from the group consisting of ethylene homo-polymers (polyethylene), heterogeneous or homogeneous ethylene-α-(C₄-C₈)-olefin copolymers, ethylene-cyclic olefin copolymers, such as ethylene-norbornene copolymers, ethylene-vinyl acetate co-polymers, ethylene-(C₁-C₄) alkyl acrylate or methacrylate co-polymers, such as ethylene-ethyl acrylate co-polymers, ethylene-butyl acrylate co-polymers, ethylene-methyl acrylate co-polymers, and ethylene-methyl methacrylate co-polymers, ethylene-acrylic acid co-polymers, ethylene-methacrylic acid co-polymers, ionomers, and blends thereof in any proportion.

Propylene polymers suitable for said outer layer (b) are selected from the group consisting of propylene homo-polymer and propylene co- and ter-polymers with up to 50 wt. %, preferably up to 35 wt. %, of ethylene and/or a (C₄-C₁₀)-α-olefin, and more preferably from the group consisting of polypropylene, propylene-ethylene co-polymers, propylene-ethylene-butene co-polymers and propylene-butene-ethylene copolymers with a total ethylene and butene content lower than about 40 wt. %, preferably lower than about 30 wt. %, and even more preferably lower than about 20 wt. %, and blends thereof in any proportion.

Suitable modified polyolefins that can be used for said outer layer (b) include polymers obtained by co-polymerization of the homo-polymer of the olefin or co-polymer thereof with maleic acid, fumaric acid or the like unsaturated acid, or a derivative thereof such as the anhydride, ester or metal salt or the like, as well as polymers obtained by incorporating into the olefin homo-polymer or co-polymer, by blending or preferably by grafting, an unsaturated carboxylic acid, e.g., maleic acid, fumaric acid or the like, or a derivative thereof such as the anhydride, ester or metal salt or the like.

Preferably, when used in said outer layer (b) the modified polyolefins will be blended with one or more polyolefins typically employed in a major proportion. Examples are for instance blends of a major proportion of one or more polymers of the group of ethylene homo- and copolymers and propylene homo- and co-polymers, with a minor proportion of anhydride grafted ethylene-α-(C₄-C₈)-olefin copolymers, anhydride grafted ethylene-vinyl acetate copolymers, rubber modified ethylene-vinyl acetate copolymers, ethylene/propylene/diene (EPDM) copolymers, and the like.

The outer layer (b) may also comprise one or more thermoplastic (co)polyesters. Useful (co)polyesters include those made by condensation of polyfunctional carboxylic acids with polyfunctional alcohols, polycondensation of hydroxycarboxylic acids, and polymerizations of cyclic esters, i.e. lactones. Homopolymers and copolymers can be used, wherein the copolyesters are those formed starting from two or three species of acid component and/or alcohol component, or more than one hydroxycarboxylic acid or lactone or a combination of any of these.

Exemplary polyfunctional carboxylic acids (and their derivatives such as anhydrides or simple esters like methyl esters that are suitable in the production of (co)polyesters) include aromatic dicarboxylic acids and derivatives (e.g., terephthalic acid, isophthalic acid, naphthalenic acid, dimethyl terephthalate, dimethyl isophthalate) and aliphatic dicarboxylic acids and derivatives (e.g., adipic acid, azelaic acid, sebacic acid, oxalic acid, succinic acid, glutaric acid, dodecanoic diacid, 1,4-cyclohexane dicarboxylic acid, dimethyl-1,4-cyclohexane dicarboxylate ester, dimethyl adipate).

Exemplary polyfunctional alcohols include dihydric alcohols such as ethylene glycol, 1,2-propanediol, 1,3-propanediol, 1,3 butanediol, 1,4-butanediol, 1,4-cyclohexanedimethanol, 2,2-dimethyl-1,3-propanediol, 1,6-hexanediol, and the like glycols.

Exemplary hydroxycarboxylic acids and lactones include glycolic acid, lactic acid, 3-hydroxybutyric acid, 3-hydroxyvaleric acid, 4-hydroxybenzoic acid, 6-hydroxy-2-naphthoic acid, pivalolactone, caprolactone, and the like.

The composition of said outer layer (b) will generally depend on the final application foreseen for the end structure.

In one embodiment said outer layer (b) will be used as the heat-sealable layer of the film, i.e. the outer film layer which is involved in the sealing of the film to close the end package. In such a case its composition will be suitably selected depending on the particular substrate it will be sealed to. For instance if the film has to be heat-sealed to itself, like in the manufacture of bags or pouches, preferably said outer layer (b) will be a polyolefin layer as polyolefins are known to be heat-sealable at low temperatures. If the film of the present invention is used in tray lidding applications it may be convenient or necessary to have an outer layer (b) comprising polyolefins and/or modified polyolefins if the food contact layer of the tray, the layer to which the film would have to be sealed, is a polyolefin layer or a suitable peelable polyolefin blend, when an easy-to-open package is desired. When the film of the present invention is used in tray lidding applications and the film according to the present invention has to be heat-sealed to a polyester support, such as a rigid or foamed PET tray, a suitable outer layer (b) will comprise a copolyester, e.g., a PETG; or, again, if the substrate to which the film according to the present invention has to be sealed is a tray of rigid or foamed polylactic acid, a suitable outer layer (b) may comprise one or more of amorphous polylactic acid, polyglycolic acid, polycaprolactone, polybutylene succinate, polybutylene succinate-adipate, polybutylene adipate-terephthalate (Ecoflex® by BASF), poly(hydroxybutyrate), poly(hydroxybutyrate-co-valerate) or the like extrudable resins that can be heat-sealed to a polylactic acid surface.

The outer layer (b) will have a thickness at least two or three times higher than the thickness of the thicker microlayer in the sequence (a). Preferably the outer layer (b) will be a standard layer, i.e., a layer with a thickness higher than 5 μm, but in case of thin films, such as the solid-state oriented films having a thickness of from 15 to 30 μm, its preferred thickness may be as low as 3 or 4 μm. The thickness of the outer layer (b) may be up to about 80% of the overall thickness of the structure, preferably up to about 60% and more preferably up to about 50%.

A tie layer is present between the microlayer sequence (a) and the outer layer (b) to provide for a sufficient adhesion between said layers. The adhesive resin preferably comprises one or more modified polyolefins, possibly blended with one or more polyolefins. Specific, not limitative, examples thereof may include: ethylene-vinyl acetate copolymers, ethylene-(meth)acrylate copolymers, ethylene-α-(C₃-C₈)olefin copolymers, any of the above modified with carboxylic or preferably anhydride functionalities, elastomers, and a blend of these resins.

In a more preferred embodiment of the present invention, the multi-layer, gas-barrier, film will comprise in addition to the microlayer sequence (a), the outer layer (b), and a tie layer positioned between the microlayer sequence (a) and the outer layer (b), also a second outer layer (c).

Depending on the final use of the film of the present invention the second outer layer (c) may have a composition identical or similar to that of the first outer layer (b), e.g., when for instance lap-sealable films are desired, or said second outer layer (c) may comprise any thermoplastic material that may be suitable for use in an abuse resistant layer when for instance pouches, bags, lids, or deep-drawable sheets are desired. Thus suitable resins for the second outer layer (c) include for instance polyolefins, modified polyolefins, polyesters, copolyesters, polyamides, copolyamides, polystyrene polymers, and blends thereof.

Suitable polyolefins that can be used for the second outer layer (c) are ethylene homo-polymers, ethylene co-polymers, propylene homo-polymers, propylene co-polymers and blends thereof as described for the first outer layer (b). Preferred in said class are ethylene homopolymers, such as LDPE and HDPE, ethylene-α-(C₄-C₈)-olefin copolymers, particularly those with a density of from about 0.890 to about 0.935 g/cm³, and more preferably of from about 0.895 and about 0.930 g/cm³, ethylene-vinyl acetate copolymers, particularly those with a vinyl acetate content of from about 4 to about 18% by weight, ionomers, polypropylene homopolymers, propylene-ethylene co-polymers, propylene-ethylene-butene copolymers, propylene-butene-ethylene copolymers, and their blends.

Polyamides and co-polyamides that are preferably employed for the second outer layer (c) are for instance those (co)polyamides characterised by a high crystalline melting point, such as certain aliphatic or partially aromatic polyamides or copolyamides, e.g. polyamide 6, MXD6, polyamide 66, copolyamide 6/66, copolyamide 6/12, copolyamide MXD6/MXDI, etc. They can be used alone or in blends. They can also be used blended with other polyamides such as for instance amorphous polyamides, e.g. copolyamide 6I/6T, polyamide 6I, etc.

The second outer layer (c) may also comprise polystyrene polymers.

In a preferred embodiment however the second outer layer (c), if present, will comprise one or more thermoplastic polyesters or copolyesters, as described for the outer layer (b). Exemplary polyesters in case said outer layer (c) is used as the film abuse resistant layer preferably include poly(ethylene terephthalate) (“PET”), poly(butylene terephthalate) (“PBT”), and poly(ethylene naphthalate) (“PEN”). If the polyester includes a mer unit derived from terephthalic acid, then such mer content (mole %) of the diacid of the polyester may be at least about any the following: 70, 75, 80, 85, 90, and 95%. The (co)polyester may be amorphous, or may be partially crystalline (semi-crystalline), such as with a crystallinity of at least about, or at most about, any of the following weight percentages: 10, 15, 20, 25, 30, 35, 40, and 50%.

The thickness of said second outer layer (c), when it is present, is typically comprised between about 2 and about 50% of the overall structure, preferably between about 4 and about 45%, more preferably between about 6 and about 40%, and yet more preferably between about 8 and about 35%.

In a more preferred embodiment the film of the present invention comprises, in addition to the alternating sequence (a), the outer layers (b) and (c), and a tie layer between the alternating sequence (a) and the first outer layer (b), also a tie layer between the alternating sequence (a) and the second outer layer (c). The adhesive resin used for said latter tie layer may be equal to or different from that used for the tie layer between the alternating sequence (a) and the first outer layer (b) and preferably comprises one or more modified polyolefins, possibly blended with one or more polyolefins.

If necessary or advisable one or more other layers may be positioned between the alternating sequence (a) and the outer layers (b) and (c). Suitable layers may include bulk layers, to increase the thickness of the overall structure; seal-assistant layers, directly adhered to the outer layer (b), to improve sealability of the structure via outer layer (b) particularly in difficult conditions; cohesive failure layers, directly adhered to the outer layer (b) used as the film heat-sealable layer to provide a film or sheet suitable for the manufacture of an easy-openable package; a pressure sensitive layer adhered to the outer layer (b) used as the film heat-sealable layer to provide for a film or sheet suitable for the manufacture of a reclosable package; shrink layers, to induce compatible shrinkage of the overall multilayer film structure, if needed; and tie or adhesive layers used to increase the bond between the alternating sequence (a) and another layer positioned between said alternating sequence (a) and any of the outer layers, or between any of the outer layers and another layer positioned between said outer layer and the alternating sequence (a).

The thickness of any of these layers will vary depending on the particular purpose of the layer: tie or adhesive layers will typically have a very limited thickness, in the order of few (1-5) μm, while bulk and shrink layers will typically be reasonably thicker, e.g., 20, 30, 50, 70, 100, 150, 200 or even more μm, and the other types of layers will have an intermediate thickness.

In all the film layers, the polymer components may contain appropriate amounts of additives normally included in such compositions. Some of these additives are preferably included in the outer layers or in one of the outer layers, while some others are preferably added to inner layers. These additives include slip and anti-block agents such as talc, waxes, silica, and the like, antioxidants, stabilizers, plasticizers, fillers, pigments and dyes, cross-linking inhibitors, cross-linking enhancers, oxygen scavenging compositions, UV absorbers, antistatic agents, anti-fog agents or compositions, and the like additives known to those skilled in the art of packaging films.

The end films will generally have a total thickness that may be comprised between about 15 μm and about 1,200 μm, depending on whether the structure is solid-state oriented or not and depending on the particular use foreseen. As an example, films with a thickness comprised between about 15 and about 30 μm will typically be oriented, heat-shrinkable, annealed, or heat-set structures, suitable for use in shrink wrapping or tray lidding applications; films with a thickness comprised between about 30 and about 150 μm, can be either cast or oriented, heat-shrinkable, annealed, or heat-set films, suitable for many different applications including the manufacture of bags, casings, pouches, or in flow-wrap, thermoform, or thermoform-shrink applications; films or sheets with a thickness higher than 150 μm are generally cast non-oriented structures, mainly used in the manufacture of pouches or in thermoforming and deep-drawing applications.

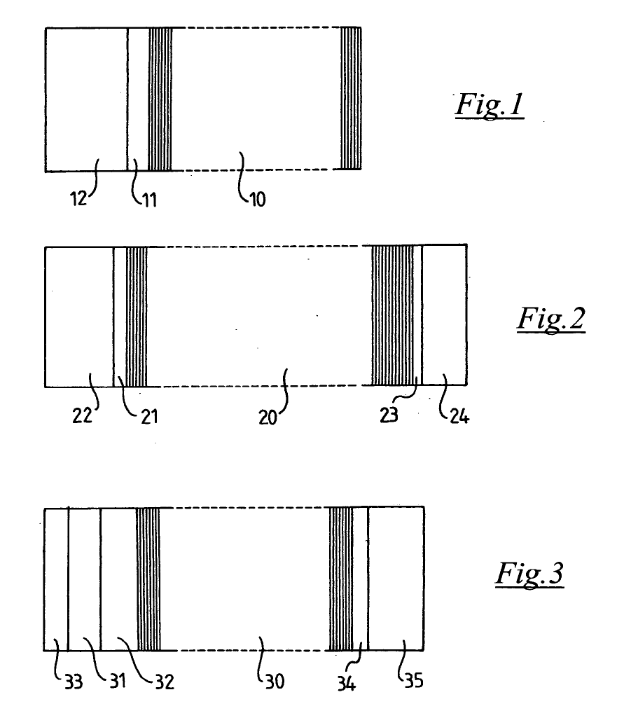

Representative examples of films according to the present invention are illustrated in FIGS. 1 to 3. FIG. 1 illustrates a first embodiment of multilayer film where 10 represents the alternating sequence (a) (A/B/C)ₙ, 12 is the outer layer (b), and 11 is a tie layer adhering the outer layer (b) to the alternating sequence (a). FIG. 2 illustrates a second preferred embodiment of a multi-layer film where 22 is the first outer layer (b), 20 is the alternating sequence (a) (A/B/C)ₙ, 24 is the second outer layer (c) and 21 and 23 represent two tie layers that can be equal or different and are used to increase the adhesion of the outer layers to the core alternating sequence. FIG. 3 illustrates a third preferred embodiment of a multilayer film where 33 is the first outer layer (b) that will be used as the heat-sealable layer in the end film, 30 is the core alternating sequence (a) (A/B/C)ₙ, 31 is a cohesive failure layer directly adhered to the outer heat-sealable layer (b) that in this case would be fairly thin, typically thinner than 10 μm, and preferably thinner than 8 μm, 32 is a tie layer binding the cohesive failure layer 31 to the core alternating sequence (a) 30, 35 is the second outer layer (c) and 34 is a second tie layer, that may be equal or different from tie layer 32, and is used to increase the bond between the second outer layer 35 and the core alternating sequence 30. The film of this latter embodiment can be heat-sealed via the first outer layer (b) either to itself or to a different thermoplastic element and provide for an easy-to-open package. In these embodiments n is typically an integer from 3 to 300, preferably at least 4, at least 5, at least 6, at least 7, at least 8, from 9 to 273, more preferably from 16 to 256.

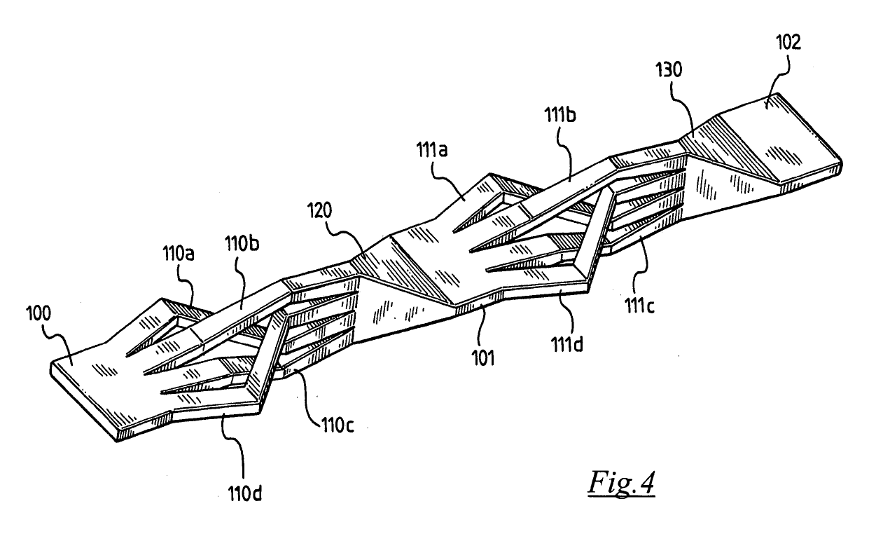

As indicated above the alternating sequence (a) may be obtained by conventional coextrusion technologies, when the number n of repeating units (a′) is limited to 3, 4 or 5, but generally and preferably the alternating sequence (a) is obtained using a multiplier device, a device that comprises a series of multiplying elements which extend from a coextrusion block connected to the extruders of the resins for the layers of the repeating unit (a′), to a final discharge die where the melt laminate forms a film with a number of layers dictated by the number of layers in the repeating unit (a′), the number of multiplying elements and the number of ramps in each of these elements. An example of multiplier device is illustrated in FIG. 4. In said FIG. 4, 100 is a die element disposed in the melt flow passageway from the device for the coextrusion of the resins of the repeating unit (a′), device which is not illustrated in FIG. 4. The die element 100 divides the melt flow passage into four passages, 110a, 110b, 110c, and 110d, leading the divided melt flows, each containing the microlayer sequence of the repeating unit (a′), to the expansion platform 120 where the split melt flows are stacked one on top of the other and the obtained melt laminate is then expanded transversally and conveyed to a second die element 101. The melt flow in said second die element will contain a sequence of four repeating units (a′) as the melt flow has been divided in four packets in the first die element. The process is then repeated through the second multiplier element where four separated melt flows, each containing the sequence of 4 repeating units, (a′)₄, are formed and conveyed through their respective passageways 111a to 111d to a second expansion platform 130, where they are stacked one on top of the other giving a melt laminate with an alternating sequence comprising 16 repeating units (a′), i.e., (A/B/C)₁₆. In said FIG. 4, 102 represents the discharge die through which the multilayer film of the present invention is then finally extruded. If desired, one or more additional multiplying element can be interposed between the second expansion platform 130 and the final extrusion die 102. If a multilayer film is desired which also comprises other layers in addition to the alternating microlayer sequence (a), said additional layers can be pre-formed and then heat- or glue-laminated to one or both outer surfaces of the obtained alternating sequence (a); or they can be extrusion coated on one or both of the outer surfaces of the obtained alternating sequence (a); they also may be coextruded with the alternating sequence (a) by passing the molten flow corresponding to the desired alternating sequence (A/B/C)ₙ into a suitable feedblock and then through a suitable coextrusion die; or they may be obtained by any suitable combination of the above methods.

In a most preferred embodiment the multilayer film of the present invention is however coextruded.

In line of principle however the manufacturing process may be suitably adapted to obtain films with any desired number of repeating units n, as the first coextrusion step is not necessarily limited to a sequence of layers corresponding to a single unit (a′), but it is possible to start with a coextruded sequence of layers corresponding to e.g., two or three repeating units; the multiplying devices can suitably be combined and not necessarily need to be multiple of the same number; and it is possible to foresee at the end of the multiplying process a further step where a coextruded repeating unit (a′) is either coextruded, extrusion-coated or laminated to the precursor structure where the alternating microlayer sequence comprises n−1 repeating units.

The films of the present invention may be cross-linked if desired. Cross-linking is typically obtained by passing the film or sheet through an irradiation vault where it is irradiated by high-energy electrons. Depending on the characteristics desired, this irradiation dosage can be up to about 200 kGy, preferably up to about 150 kGy, more preferably up to about 130 kGy. Typically for the irradiated structures the irradiation dosage will be comprised between 10 and 200 kGy, preferably between 20 and 150 kGy and more preferably between 30 and 130 kGy.

The films according to the present invention may or may not be solid-state oriented. If solid-state oriented, they may be uniaxially oriented or, preferably, bi-axially oriented, i.e., oriented in both the MD and TD directions.

When solid-state oriented, the films or sheets of the present invention can then be heat-shrinkable, i.e., show a free shrink in at least one of the two directions of at least 5% at 95° C., preferably at least 10%, more preferably at least 15%, and even more preferably at least 20%; or they may be heat-set, i.e., show a free shrink lower than 3%, preferably lower than 2%, in both directions at 140° C.; or annealed, i.e., have a free shrink in at least one of the two directions of at least 15%, preferably at least 20% and even more preferably at least 25% at a temperature of 120° C. but a free shrink lower than 5% at 95° C.

Solid-state orientation is obtained by quenching the multilayer structure immediately after extrusion, then reheating the flat sheet, in either an oven using hot air or infrared heaters or by passing it over a series of heated rolls, and then stretching still under heating at a temperature higher than the Tg of all the resins making up the structure but lower than the melting temperature of at least one of them (the orientation temperature), either in only one or preferably in both directions. Biaxial orientation can be obtained using a simultaneous tenterframe, such as for instance a LISIM™ line by Brückner or a pantograph line such as a Dornier line, but for the structures of the present invention this can also be obtained, easily and effectively, using a more conventional sequential tenterframe. It has been found in fact that a structure with a microlayer alternating sequence (a) can be solid-state oriented much more easily than a structure with a single layer of a thickness corresponding to the sum of the thickness of the plurality of the microlayers of the same resin. This is particularly important when layer B is an EVOH layer. In fact it has been found that with a structure comprising an alternating sequence of microlayers of EVOH it is possible to get an oriented film (also with high stretching ratios, e.g., up to about 5:1 in each direction), uniform in thickness, and without any processability problems, using a conventional sequential tenterframe (with a first longitudinal stretching, followed by a second transverse stretching and optionally a third longitudinal one). On the contrary high orientation ratios cannot be applied in the solid-state sequential tenterframe orientation of a structure comprising the same total amount of EVOH but in a single layer and even when low orientation ratios are applied, strictly controlled orientation conditions are required to give an acceptably stable process and reduce the problems of non uniform thickness.

In the sequential tenterframe the stretching in MD is obtained by drawing the sheet between rolls moving at different speeds, with the downstream set moving at a higher speed and the stretching in TD is accomplished in a heated area using two continuous chains mounted on each side of the sheet and bearing clamps that grip the edges of the sheet. The two side chains gradually move apart and as they do they drive the sheet in the transverse direction between them, until the end of the transverse stretch section where the clamps open and the chains turn around a wheel and return to the beginning of the transverse stretching section. If a heat-shrinkable structure is desired having a controlled shrink at low temperatures or if an annealed or heat-set oriented structure is desired, at the end of the TD stretching section the side chains are maintained parallel or slightly converging and the oriented film, still clamped to the chains, is allowed either to relax or is heat-set at the suitably selected temperature, typically comprised between 40-50° C. and 150-160° C.

The free shrink of the film is determined by measuring the percent dimensional change in a 10 cm×10 cm film specimen when subjected to selected heat in a suitable liquid according to ASTM D2732.

The cast films of the present invention not solid-state oriented are particularly suitable for use in thermoforming processes for the manufacture of containers such as trays, cups, pods, and the like containers. In particular it has been shown in connection with representative structures where layer B is an EVOH layer, that the films of the present invention can be formed to a depth more than 5% larger than the corresponding films with the same total amount of EVOH but in a single layer and the same total amount of polyamide either in a single layer or divided in two layers. Furthermore the gas barrier properties of the structures of the present invention will also be improved with respect to the gas barrier properties of comparable structures where the same total amount of the different resins are combined in two or in three layers. In particular in fact the films of the present invention where layer B is an EVOH layer have better gas-barrier properties and said properties are less impaired by an increase in relative humidity so that the OTR of these films at 0% and particularly at 100% R.H. is lower.

The gas-barrier cast films of the present invention are particularly useful for the vacuum or modified atmosphere packaging of various products. For said use, once the product is loaded in the container obtained from the film of the invention (e.g., a pouch/bag or a thermoformed container) where the outer layer (b) is the layer in contact with or closer to the product, the atmosphere is removed and possibly replaced by a suitable gas or gas mixture, and then the pouch/bag is closed by heat-sealing the film to itself at the pouch/bag mouth or in case the film of the invention is used as a rigid container or support either a gas-barrier lid is heat-sealed on the rim of the container or the container/support with the product thereon is submitted to a vacuum skin packaging step where a top web drapes down all around the product to the packaged and seals to the surface of the container/support where said surface is free.

For applications where the film of the invention is thermoformed, a film also including a second outer abuse resistant layer (c) is highly preferred as the contact of a very thin outer layer with the thermoforming mold may negatively affect the appearance of the outer surface. Preferably for said application a suitable outer layer (c) would be a (co)polyamide or even more preferably a (co)polyester layer.

Typical thicknesses for thermoforming applications of the cast films will vary from at least about 50 μm, for very shallow profile trays, to about 1,200 μm, preferably from about 70 to about 850 μm, more preferably from about 100 to about 500 μm, and even more preferably from about 120 to about 400 μm, and still even more preferably from about 150 to about 300 μm.

Cast films according to the present invention may also be used, in a thinner version, as lidding or wrapping films or for the manufacture of pouches in HFFS or VFFS processes. In such a case a suitable thickness can be comprised between about 30 and about 150 μm, preferably between about 35 and 130 μm, more preferably between about 40 and 110 μm, and even more preferably between about 45 and about 100 μm.

For some of these applications it is however preferred to use solid-state oriented films according to the present invention, either heat-shrinkable, annealed, or heat-set.

Heat-shrinkable or annealed films, with a thickness typically comprised between about 40 and about 160 μm can suitably be employed in the so-called “thermoform-shrink” processes. These are processes that involve the thermoforming of a solid-state oriented heat-shrinkable film to form a flexible container. In these methods the product to be packaged is loaded in the container thus obtained, and the package is then closed, once air is evacuated from the inside, with a lid, which may be e.g., a flat film, another thermoformed flexible container, or a stretched film, that is sealed to the flange of the loaded container. Shrinkage of the packaging material, induced by a heat-treatment, then provides the desired tight appearance to the end vacuum package. In such a case the optimum thickness will depend on the depth desired for the formed container. For medium depths a preferred thickness will be generally in the range between 50 and 100 μm, while for high depths a preferred thickness will be typically in the range between 70 and 160 μm.

The films of the present invention, particularly in the embodiments where the second outer layer c) comprises a high melting resin that is adapted to be in contact with a sealing bar during a heat sealing operation without sticking, can be used also as the lidding film that closes the package. If also the lid is thermoformed, then the same thickness range will be appropriate, while if the film is sealed to the flange of the thermoformed container as a flat lid, a thickness comprised between about 20 and about 35 μm will be sufficient and if it has to be stretched to a certain extent, because the product loaded into the thermoformed container slightly protrudes therefrom, then a thickness of e.g., from about 25 to about 40 μm, will be preferred.

The heat-shrinkable films of the present invention can be employed also for other packaging applications, in particular for any packaging application where a shrink thermoplastic material can be employed, such as shrink wrapping, shrink bag, etc. For these uses the solid state oriented shrink film may have a thickness ranging from about 20 to about 120 μm, preferably between 20 and 40 μm for shrink film applications and between 40 and 120 μm for shrink bag or seamed casing applications.

The solid-state oriented and heat set films, typically having a thickness of from about 35 to about 75 μm, preferably from about 40 and about 65 μm, may suitably be employed for use in the manufacture of pouches or in horizontal or vertical Form-Fill-Seal processes. Also for this application the film preferably comprises also a second outer layer (c). In a preferred embodiment for this application both outer layers are polyolefin layers and the structure is symmetrical. In another preferred embodiment the second outer layer (c) will be higher melting with respect to the first outer layer (b) used as the film sealant layer. Thus the film may have both outer layers of polyolefins where however the composition of said layers would be different, e.g. with the outer layer (b) being ethylene-based and the outer layer (c) being propylene-based, or outer layer (b) is a polyolefin layer while outer layer (c) comprises (co)polyamides and/or (co)polyesters.

The following examples are presented for the purpose of further illustrating and explaining the present invention and are not to be taken as limiting in any regard. Unless otherwise indicated, all parts and percentages are by weight.

In the following examples the resins indicated in Table I below have been employed:

TABLE I

| | |
|---|---|
| EC1 | Homogeneous ethylene-α-olefin copolymer with d = 0.902 |
| | g/cm³ and MI = 3 g/10 min - Affinity PL1850G by Dow |
| EC2 | Homogeneous ethylene-α-olefin copolymer with d = 0.900 |
| | g/cm³ and MI =1.3 g/10 min - Exact 3128 by Exxon |
| EC3 | Isotactic ethylene-propylene copolymer (1.3% Et) ED0103 by |
| | Total Petrochemical |
| PET | Polyethylene-terephtahalate copolymer - Eastman PET 9921W |
| | by Eastman Chemicals |
| PA1 | PA 6 - m.p. 220° C. - Ultramid B40 by BASF |
| PA2 | Nanopolyamide 6 - 1022C2 NCH Nylon 6 by UBE |
| EVOH | Ethylene-vinyl alcohol copolymer (>40 mol. % of ethylene) |
| | Soarnol AT4403 by Nippon Goshei |
| EVOHr | Ethylene-vinyl alcohol copolymer (32 mol. % of ethylene) |
| | retortable grade by Nippon Goshei |
| AD1 | Maleic anhydride modified linear polyethylene - Admer |
| | AT2146E by Mitsui |
| AD2 | Maleic anhydride modified linear low density |
| | polyethylene - Admer AT1053A by Mitsui |
| MB1 | Masterbatch EVA based of silica (1.5%) and amide waxes (3%) |
| MB2 | Masterbatch PET based of silica and waxes |
| MB3 | Masterbatch HDPE based of silica and waxes |

Melt Flow Indexes (MI's) are measured by ASTM D-1238 and are reported in grams/10 minutes. Unless otherwise indicated the conditions used are 190° C./2.16 kg.
Unless otherwise specifically indicated, all percentages are by weight.

### Example 1

A melt stream of a total of 48 microlayers repeating 16 times the sequence A/B/C where A is PA1, B is EVOH, and C also is PA1 was obtained by first co-extruding the resins through a three layer coextrusion feedblock apparatus and then feeding the resulting first composite stream through a series of two four-channel multiplying devices by EDI. The thickness of each of the EVOH and PA1 layers was about 1.1 μm. The 48-layer melt stream was then passed as the core layer in a five-layer feedblock apparatus together with an EC1 outer layer (b) of 75 μm, an outermost abuse resistant layer (c) of a blend of 98% PET and 2% MB2 of 87.5 μm, and two intermediate adhesive layers of AD1 of 17.5 μm each, positioned between the outer layers and the core sequence (a).

The overall structure is indicated in Table II below.

### Example 2

The procedure of Example 1 was repeated by decreasing the thickness of each of the EVOH and PA1 layers to 0.8 μm, that of the outer sealant layer (b) to 52.5 μm, that of the outer abuse layer to 61.3 μm, and that of each of the adhesive intermediate layers to 12.2 μm.

The overall structure of this Example is also reported in Table II below.

### Examples 3 and 4

The structures of Examples 3 and 4 (resins and thickness of the different layers) are reported in Table II below.

The process used for the manufacture of these cast structures is substantially that described in Example 1.

TABLE II

| | Outer | | intermediate | Alternating | intermediate | Outer abuse- | |
|---|---|---|---|---|---|---|---|
| | sealant | | adhesive | sequence | adhesive | resistant | |
| Ex. no | layer (b) | | layer | (a) | layer | layer (c) | |
| 1 | EC1 | 90% | AD1 | (PA1/EVOH/PA1)₁₆ | AD1 | PET | 98% |
| (250 μm) | MB1 | 10% | (17.5 μm) | (52.5 μm - 1:1:1) | (17.5 μm) | MB2 | 2% |
| | (75 | μm) | | | | (87.5 | μm) |
| 2 | EC1 | 90% | AD1 | (PA1/EVOH/PA1)₁₆ | AD1 | PET | 98% |
| (175 μm) | MB1 | 10% | (12.2 μm) | (36.9 μm - 1:1:1) | (12.2 μm) | MB2 | 2% |
| | (52.5 | μm) | | | | 61.3 | μm) |
| 3 | EC3 | 50% | AD2 | (PA1/EVOHr/PA1)₁₆ | AD2 | EC3 | 50% |
| (150 μm) | EC2 | 44% | (15 μm) | (45 μm - 1:1:1) | (15 μm) | EC2 | 44% |
| | MB3 | 6% | | | | MB3 | 6% |
| | (37.5 | μm) | | | | (37.5 | μm) |
| 4 | EC1 | 90% | AD1 | (PA1/PA2/PA1)₁₆ | AD1 | EC1 | 90% |
| (150 μm) | MB1 | 10% | (15 μm) | (45 μm - 1:1:1) | (15 μm) | MB1 | 10% |
| | (37.5 | μm) | | | | (37.5 | μm) |

The film of Example 2 was submitted to a series of tests to evaluate its thermoformability in comparison with a similar structure where the sequence (a) was replaced by a single unit PA1/EVOH/PA1 where the thickness of each of these three layers was 12.3 μm, thus corresponding to the sum of the thickness of the corresponding 16 layers of the alternating sequence (a). Packs of 135 mm×80 mm were made with a varying depth and it was shown that the structure of Example 2 could be thermoformed at 75° C. up to a depth of 90 mm, while with the comparative structure it was not possible to go beyond 85 mm as the pouch would break during forming.

The mechanical properties of representative films of the invention were evaluated by measuring the puncture resistance at 30° C. by an internal test method that is described shortly in the following: a sample (6.5×6.5 cm) of the film is fixed in a specimen holder connected to a compression cell mounted on a dynamometer (an Instron tensile tester), when the dynamometer is started, a punch (a punching sphere, 5-mm in diameter soldered on a plunger) is brought against the film sample at a constant speed (30 cm/min) at a temperature of 30° C., and the force needed to puncture the sample is thus determined. The film of Example 2 was submitted to this test and the puncture resistance thus evaluated was 6,700 g.

### Example 5

The film of Example 1 was quenched at the exit of the die following the final coextrusion step, then reheated and oriented biaxially in a sequential tenterframe with stretching ratios of 3.0:1 in the longitudinal direction and 3.2:1 in the transverse direction. The orientation temperatures were in the range 80-91° C. for the MD orientation and in the range 100-105° C. for the TD orientation, while the final high temperature annealing step was carried out at about 140-145° C.

A 40 μm biaxially oriented film was obtained with a free shrink at 120° C. of 18% in MD and 21% in TD.

### Examples 6 to 10

Five symmetrical cast films, 250 μm thick, having the following identical layer sequence

90% EC1+10% MB1/AD1/(PA1/EVOH/PA1)₁₆/AD1/90% EC1+10%

MB1 but differing for the thickness of the core multiplied sequence and for the thickness of the outer layers that is varied to compensate the change in thickness of the core sequence, have been prepared following exactly the same procedure described in Example 1. Table III below reports for each of these films the thickness of the multiplied core portion and its % with respect to the total thickness of the film.

TABLE III

| Example | Thickness of the (PA1/EVOH/PA1)₁₆ | % over the |
|---|---|---|
| no. | portion (μm) | total thickness |
| 6 | 122 | 48 |
| 7 | 100 | 40 |
| 8 | 75 | 30 |
| 9 | 50 | 20 |
| 10 | 25 | 10 |

### Comparative Examples 11 and 12

These Comparative Examples have been prepared by following the same procedure as in Examples 6 and 10 respectively but excluding the multiplier so that the films of these Comparative Examples contain a single core unit PA1/EVOH/PA1, instead of a sequence of 16 repeating units, said single unit having however the same thickness indicated above for the core sequence of Examples 6 and 10 respectively.

The Oxygen Transmission Rate (OTR) of the films of Examples 6 to 10 and of Comparative Examples 11 and 12 has been tested according to the ASTM method D-3985 at 23° C. and 0% RH and 100% RH. At 100% RH the sandwich method, wherein both sides of the specimens to be tested are in contact with water, was applied and the test was performed after 4 days of conditioning as well as after 10 days of conditioning in view of the thickness of the films.

The results, expressed in cm³/m²/day are reported in Table IV below

TABLE IV

| Film of Example | | OTR 100% RH - 4 | OTR 100% - 10 |
|---|---|---|---|
| no. | OTR 0% RH | days conditioning | days conditioning |
| 6 | <2 | 2 | 8 |
| Comparative 11 | 2 | 4 | 18 |
| 7 | <2 | 4 | 10 |
| 8 | <2 | 4 | 12 |
| 9 | 5 | 13 | not determined |
| 10 | 6 | 40 | 62 |
| Comparative 12 | 6 | 48 | 70 |

1. A multi-layer, gas-barrier, thermoplastic film or sheet comprising
a microlayer sequence (a) comprising a number n of identical repeating units (a′), each comprising the microlayer sequence A/B/C, wherein A is a microlayer comprising a major proportion of one or more thermoplastic (co)polyamides, B is either a microlayer comprising a major proportion of one or more ethylene-vinyl alcohol copolymers or a microlayer comprising a major proportion of a (co)polyamide characterized by an OTR of less than 100 cm³.25 μm/m².day.bar at 23° C. and 0% of RH, and C is either nil or a microlayer comprising a major proportion of one or more thermoplastic (co)polyamides, and n is an integer of 3 or more, said microlayer sequence (a) having a thickness of less than 50% of the total thickness of the film,
an outer layer (b) comprising one or more polymers selected from polyolefins, modified polyolefins, and thermoplastic (co)polyesters, and
a tie layer between the outer layer (b) and the microlayer sequence (a).

2. The multi-layer, gas-barrier film of claim 1 wherein the outer layer (b) comprises one or more polyolefins.

3. The multi-layer, gas-barrier film of claim 1 or 2 which also comprises a second outer layer (c).

4. The multi-layer, gas-barrier film of claim 3 wherein a tie layer is positioned between the micro-layer sequence and the outer layer (c).

5. The multi-layer, gas-barrier film of any of preceding claims 1 to 4 which is solid-state oriented, either monoaxially or biaxially.

6. The multi-layer, gas-barrier film of claim 5 which is heat-shrinkable.

7. The multi-layer, gas-barrier film of claim 5 which is heat-set.

8. The multi-layer, gas-barrier film of any of the preceding claims wherein B is a layer comprising a major proportion of one or more ethylene-vinyl alcohol copolymers.

9. The multi-layer, gas-barrier film of claim 8 wherein layer A and layer C, if present, comprise a major proportion of a polyamide selected from polyamide 6, polyamide 6/66, polyamide 6/12, and polyamide 6/69.

10. The multi-layer, gas-barrier film of any of the preceding claims wherein n is at least 4, preferably at least 5, more preferably at least 6 or 7 or 8 or 9 or 10 or 11 or 12 or 13 or 14 or 15 or 16.

11. The multi-layer, gas-barrier film of claim 3 wherein said outer layer (c) comprises one or more of polyolefins, modified polyolefins, (co)polyamides, (co)polyesters, and polystyrene polymers.

12. The multi-layer, gas-barrier film of claim 11 wherein said outer layer (c) comprises one or more polyolefins.

13. The multi-layer, gas-barrier film of claim 11 wherein said outer layer (c) comprises one or more (co)polyesters.

14. The multi-layer, gas-barrier film of any of the preceding claims which is obtained by coextrusion.

15. The multi-layer, gas barrier film of any of the preceding claims wherein the microlayer sequence (a) has a thickness equal to or less than 40% of the total thickness of the film.
